(19) United States
(12) Patent Application Publication
(10) Pub. No.: US 2026/0292779 A1
(43) Pub. Date: Sep. 24, 2026

(54) LOCATION-BASED TRACKING AREA CODES FOR NON-TERRESTRIAL NETWORKS

(71) Applicant: T-Mobile USA, Inc., Bellevue, WA (US)

(72) Inventor: Kun Lu, Bellevue, WA (US)

(21) Appl. No.: 19/084,306

(22) Filed: Mar. 19, 2025

(51) Int. Cl. H04W 64/00; H04W 8/14; H04W 84/06

(52) U.S. Cl. CPC H04W 64/003; H04W 8/14; H04W 84/06

(57) ABSTRACT

The system calculates a coverage area of a satellite in a non-terrestrial network of a telecommunication network relative to Earth. The system determines that the coverage area of the satellite covers a first tracking area corresponding to a first tracking area code (TAC). The TAC indicates to the telecommunications network a location of a wireless device within a group of network nodes. The system causes the satellite to transmit the first TAC to the first tracking area, where at least one wireless device is located in the first tracking area. The system can calculate a change to the coverage area of the satellite relative to the Earth. The system can determine that the coverage area of the satellite covers a second tracking area corresponding to a second TAC. The system causes the satellite to transmit the second TAC to the second tracking area.

### BACKGROUND

Non-Terrestrial Networks (NTNs) utilize satellites or other aerial platforms to provide connectivity, especially in areas not covered by traditional terrestrial networks. NTNs can employ Low Earth Orbit (LEO) satellites that orbit the Earth at altitudes of a few hundred kilometers. As these satellites move rapidly across the sky, their coverage areas on the ground are constantly changing.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates an embodiment of the system for updating tracking area codes in a non-terrestrial network.

FIG. 4 is a flowchart that illustrates an embodiment of the system.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to tracking area updates in non-terrestrial networks (NTNs). In terrestrial telecommunication networks, tracking area updates enable the telecommunication network to maintain location information for a wireless device when the wireless device is in idle mode and moving between different coverage areas. Tracking Area Updates (TAUs) are procedures used in telecommunication networks to maintain location information for wireless devices. When a wireless device moves between different tracking areas, the wireless device performs a TAU to inform the telecommunication network of the wireless device's new location, or the wireless device periodically performs the TAU in idle mode to routinely inform the NTN of the wireless device's TA. The TAU enables the telecommunication network to determine which network node should be used when delivering incoming calls, text messages, etc., to the wireless device. TAUs are typically triggered when a wireless device detects it has entered a new coverage area by receiving a different Tracking Area Code (TAC) broadcast by a different network node.

In terrestrial networks, tracking areas are associated with fixed base stations covering specific geographic regions. Wireless devices perform TAUs when the wireless device moves from one tracking area to another, enabling the telecommunication network to efficiently page devices and manage their mobility. However, in NTNs, due to the moving of the satellites, which includes a base station and therefore a corresponding TAC, the coverage area serviced by each satellite is not fixed relative to the Earth's surface. The constant movement of the satellites of the NTN creates a situation where wireless devices on the Earth's surface appear to change tracking areas, even when stationary, due to the satellites transmitting different TAC, which leads to unnecessary and frequent TAUs and the consumption of network resources and device power.

The disclosed technology implements a geographic location-based approach to TAUs instead of tying the TAU to the satellite's coverage areas. The system associates a TAC with a fixed geographic location to maintain accurate location information for wireless devices while minimizing unnecessary updates caused by satellite movement. The system causes each satellite in the NTN to dynamically adjust the TACs they broadcast based on their current position above the Earth and the geographic areas of the coverage area.

The system determines the current location of a satellite relative to the Earth's surface as the satellite orbits the Earth. The system broadcasts a TAC from a satellite in the NTN to a wireless device in a tracking area. The TAC corresponds to the tracking area (e.g., geographic area) of the wireless device rather than the specific satellite coverage area.

The system dynamically updates the TAC broadcast by the satellite based on the geographic location serviced by the satellite's current coverage area. For example, the system causes the satellite to broadcast a different TAC when the geographic location serviced by the satellite's coverage area changes. The wireless device, therefore, processes a TAU when the wireless device's location changes instead of when a different satellite begins providing telecommunication services to the geographic area of the wireless device. This enables wireless devices to maintain consistent tracking area information even as different satellites pass overhead while also enabling the wireless device to operate in a similar manner as it would when connected to a terrestrial network. Additionally, the system reduces the frequency of unnecessary TAUs, conserving network resources and wireless device power. The system can also maintain more accurate and stable location information for the wireless devices, improving the efficiency of paging and other network operations.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

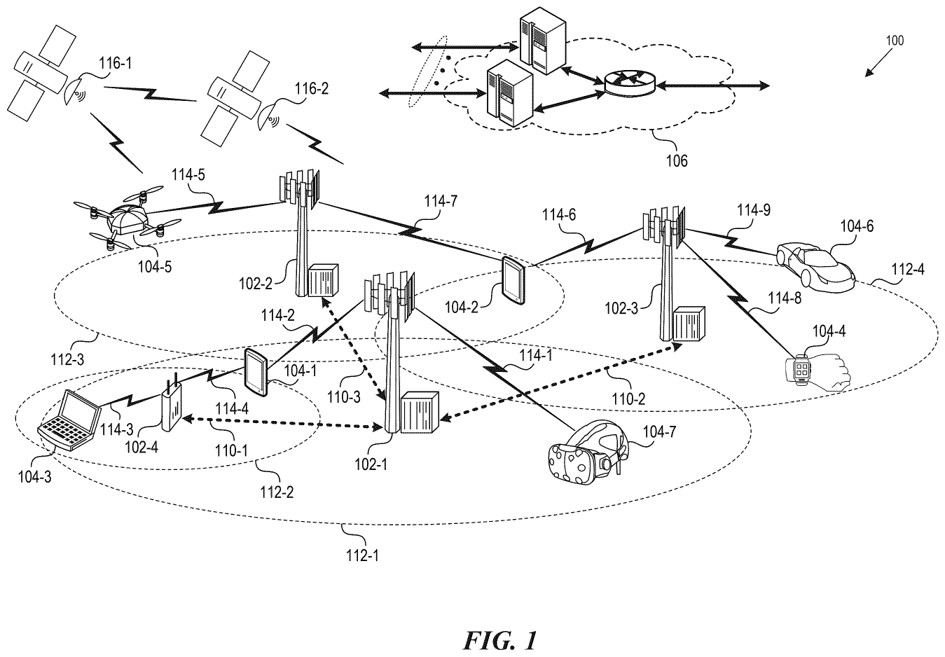

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

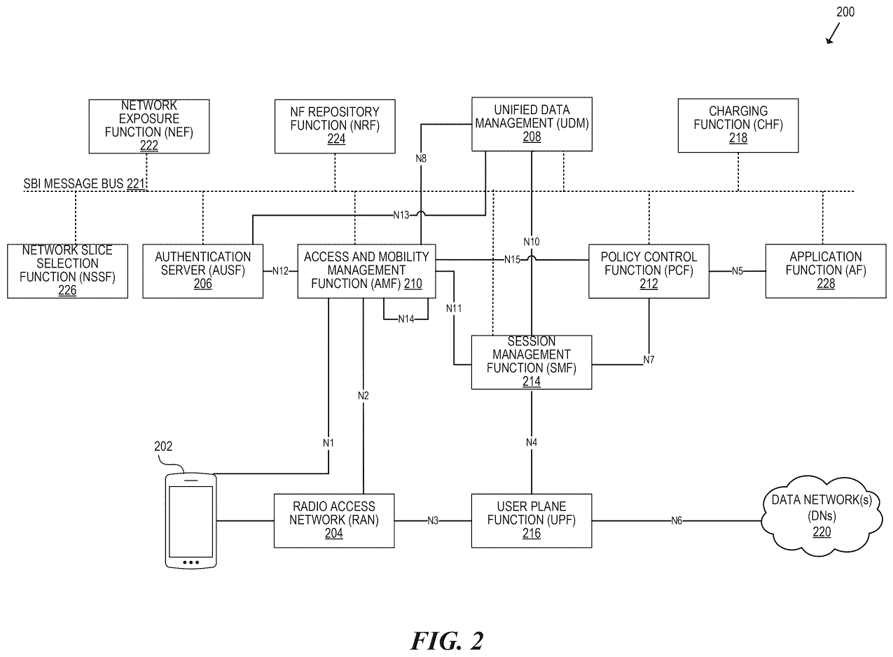

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Location-Based Tracking Area Codes

In terrestrial networks, a tracking area is a group of network nodes or base stations in a given geographic location of a telecommunication network. Instead of tracking wireless devices at the cell level, the telecommunication network uses the tracking areas to reduce signaling overhead. When a wireless device moves from one tracking area to another, a tracking area update (TAU) is performed. The TAU can be performed when the wireless device receives a new and different tracking area code from a network node. The TAU includes the tracking area code (TAC), which is a unique identifier assigned to each tracking area within the telecommunication network. Different TACs are used to identify different tracking areas. For example, a TAC can be a 16-bit value, providing a range of 0 to 65535, meaning a TAC of 1234 can represent one tracking area, while a TAC of 5678 can represent a different tracking area.

TACs are broadcast by network nodes as part of a signal called “System Information Block 1” (SIB1) that the network node continuously transmits. When a wireless device powers on or comes into a coverage area of a network node, the wireless device performs an initial attach procedure. During the initial attach procedure, the wireless device establishes a connection with the telecommunication network, receives a TAC from the network node, and registers the wireless device's location through a TAU. As the wireless device moves within the telecommunication network coverage area, a handover from one network node to another occurs (or from one network node to another within the same tracking area). The TAC remains unchanged during an intra-tracking area handover. If the wireless device moves to a network node associated with a different TAC, the wireless device performs a TAU procedure to update the telecommunication network with the new TAC received by the wireless device.

TACs increase the efficiency of the telecommunication network's mobility management, where TAUs only need to occur when a wireless device's location changes and a different TAC is received from the new network node the wireless device connects to. Additionally, the TAC helps in uniquely identifying a particular tracking area, enabling the telecommunication network to determine which tracking area the wireless device is currently in when a wireless device requests a TAU.

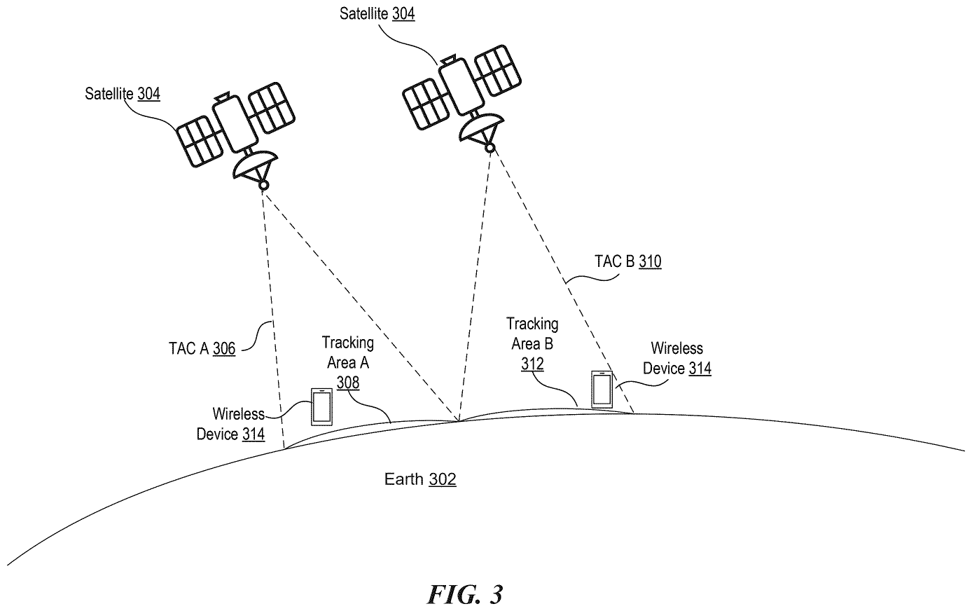

FIG. 3 is a block diagram that illustrates an embodiment of the system for updating tracking area codes in a non-terrestrial network. The satellite 304 can broadcast different tracking area codes as it moves over different tracking areas or geographic regions of the Earth 302. In terrestrial networks, a base station is stationary and broadcasts a single TAC. Due to the movement of satellite 304, if the satellite 304 broadcasted the same TAC for all locations, the wireless device 314 would need to perform a TAU each time a new satellite begins transmitting a different TAC due to the new satellite covering the geographic location of the wireless device 314. Therefore, to prevent unnecessary TAUs, the system causes the satellite 304 to broadcast a different TAC as the satellite's 304 relative tracking area above the Earth 302 changes.

As the satellite 304 orbits the Earth 302, the satellite 304 can dynamically update the tracking area code it broadcasts based on the satellite's 304 current position relative to the Earth 302. The satellite 304 can determine its current tracking area and reference a database or mapping of tracking areas to tracking area codes. This enables the satellite 304 to broadcast the appropriate TAC for the geographic area it is currently covering, even as the satellite's coverage area moves across the Earth 302.

The wireless device 314 can receive the TAC broadcast by the satellite 304 as the satellite 304 orbits above the geographic location of the wireless device 314. When the wireless device first enters a tracking area, the wireless device 314 receives a TAC broadcast by the satellite 304. The wireless device 314 can store the TAC and use the TAC as the wireless device's 314 current location reference with the telecommunication network during a TAU.

When the satellite's 304 coverage area is over tracking area A 308, the system causes the satellite 304 to broadcast TAC A 306. The wireless device 314 receives TAC A 306 from the satellite 304 when the wireless device 314 is located in tracking area A 308. Due to the orbit of the satellite 304, the satellite's 304 coverage area changes from tracking area A 308 to tracking area B 312. The system then causes the satellite 304 to broadcast TAC B 310. As the satellite 304 moves in its orbit and is replaced by other satellites covering tracking area A 308, the wireless device 314 can continue to receive TAC A 306 from the other satellites. The wireless device 314 does not need to perform a TAU unless it physically moves to a different tracking area, such as the tracking area B 312, which is associated with the TAC B 310. Although, when in idle mode (e.g., not actively interacting with a service of the telecommunication network), TAUs can be triggered at regular predefined intervals (e.g., every 15, 30, and/or 60 minutes) even when the wireless device 314 remains in tracking area A 308. When the wireless device 314 enters tracking area B 312, the wireless device 314 receives TAC B 310 from satellite 304, causing the wireless device 314 to perform a TAU.

The system, therefore, couples each TAC to a tracking area (e.g., geographic location on Earth 302) instead of the network node itself, as is done with terrestrial networks. The system determines the satellite's 304 position relative to a tracking area. Each tracking area can be associated with a specific TAC. When the satellite 304 moves from covering one tracking area to another, the satellite 304 can switch to broadcasting the TAC corresponding to the new tracking area. The system can predict the satellite's coverage area based on time and trajectory information. The system can use the prediction to determine when the satellite 304 should update the TAC being broadcast. For example, the system can calculate that at a certain time, the satellite 304 will move from covering tracking area A 308 associated with TAC A 306 to covering tracking area B 312 associated with TAC B 310. The system can cause the satellite 304 to update the TAC being broadcast at the appropriate time. In some embodiments, the system can employ artificial intelligence (AI) algorithms to analyze the satellite's 304 orbit and predict when a different TAC should be broadcast. In some other embodiments, the system can employ pre-calculated tables to map the satellite's 304 positions to a corresponding TAC. For example, the tables can be stored on the satellite 304 or in the ground-based control system.

In some embodiments, multiple satellites can broadcast the same TAC when covering the same tracking area. This redundancy can ensure consistent tracking area information for wireless devices even during satellite handovers or when multiple satellites have overlapping coverage of a tracking area. For instance, as a satellite moves out of range of wireless device 314 and satellite 304 comes into view, both satellites can broadcast the same TAC for the geographic area they are covering, maintaining continuity for the wireless device 314.

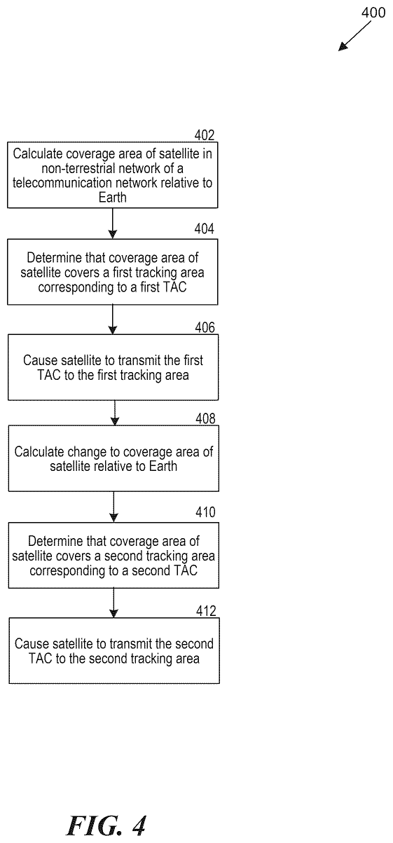

FIG. 4 is a flowchart that illustrates an embodiment of the system. In one example, the system includes at least one hardware processor and at least one non-transitory memory storing instructions, which, when executed by the at least one hardware processor, cause the system to perform the process 400.

At 402, the system calculates a coverage area of a satellite in a non-terrestrial network of a telecommunication network relative to Earth. In some embodiments, the system can measure an orbit of the satellite and calculate an expected location of the coverage area of the satellite based on the measured orbit of the satellite.

At 404, the system determines that the coverage area of the satellite covers a first tracking area corresponding to a first tracking area code (TAC). The first tracking area corresponds to a first geographic location on the Earth. The TAC indicates to the telecommunications network a location of a wireless device within a group of network nodes of the telecommunication network. In some embodiments, the system can cause the satellite to connect to a network node of a terrestrial network of the telecommunication network and receive, through the satellite, a list of TACs corresponding to different tracking areas.

At 406, the system causes the satellite to transmit the first TAC to the first tracking area, where at least one wireless device is located in the first tracking area. In some embodiments, the satellite is a first satellite, and the system can determine that a coverage area of a second satellite in the non-terrestrial network covers the first tracking area and cause the second satellite to transmit the first TAC to the first tracking area. In some other embodiments, the system can receive from the at least one wireless device a tracking area update based on the at least one wireless device entering the first tracking area and receiving the first tracking area code.

At 408, the system calculates a change to the coverage area of the satellite relative to the Earth. At 410, the system determines that the coverage area of the satellite covers a second tracking area corresponding to a second TAC, where the second tracking area corresponds to a second geographic location on the Earth. In some embodiments, the system can map the first TAC to the first tracking area and the second TAC to the second tracking area and store the mapping of the first TAC and the second TAC in a database. In some other embodiments, the first TAC is different from the second TAC.

At 412, the system causes the satellite to transmit the second TAC to the second tracking area. In some embodiments, the system can determine that the coverage area of the satellite overlaps with the first geographic area corresponding to the first TAC and the second geographic area corresponding to the second TAC, partition the coverage area into multiple parts, and cause the satellite to transmit the first TAC to the first geographic area and the second TAC to the second geographic area.

In another example, the system is located on a wireless device. The system can receive, at the wireless device, a first tracking area code (TAC) transmitted from a satellite in a non-terrestrial network of a telecommunication network. The wireless device is located in a first tracking area corresponding to a first geographic location on Earth. In some embodiments, the satellite is a first satellite in the non-terrestrial network, and the system can receive, at the wireless device, the first TAC from a second satellite in the non-terrestrial network, where the wireless device is located in the first tracking area. In some other embodiments, the system can receive, at the wireless device, the first TAC from the first satellite and a second satellite in the non-terrestrial network, where the first satellite and the second satellite have an overlapping coverage area.

The system can receive, at the wireless device, a second TAC transmitted from the satellite. The wireless device receives the second TAC when the wireless device is located in the second tracking area corresponding to a second geographic location on Earth. In some embodiments, the first TAC is different from the second TAC.

The system can transmit a tracking area update to the telecommunication network when the wireless device receives the second TAC. The tracking area update indicates the change in tracking area of the wireless device to the telecommunication network. In some embodiments, the tracking area update is a first tracking area update and the wireless device has moved back to the first tracking area from the second tracking area. The system can transmit a second tracking area update when the wireless device receives the first TAC from the second satellite, where a most recent TAC received by the wireless device is different from the first TAC.

### Computer System

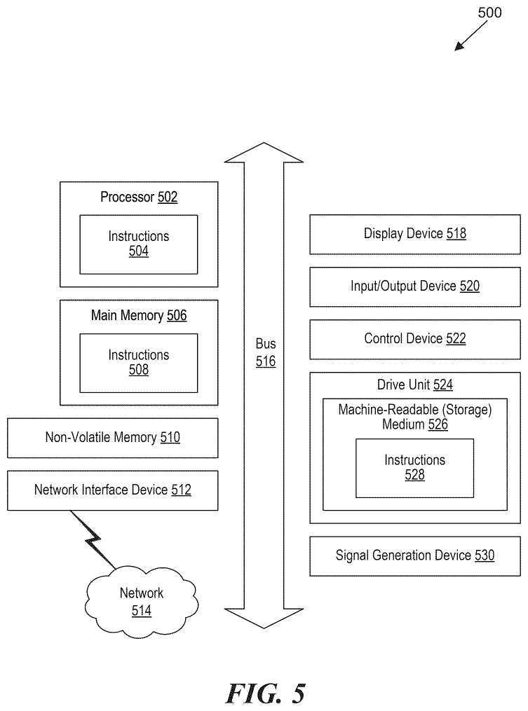

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon, wherein the instructions, when executed by at least one data processor of a system, cause the system to:
calculate a coverage area of a satellite in a non-terrestrial network of a telecommunication network relative to Earth;
determine that the coverage area of the satellite covers a first tracking area corresponding to a first tracking area code (TAC),
wherein the first tracking area corresponds to a first geographic location on the Earth; and
wherein the TAC indicates to the telecommunications network a location of a wireless device within a group of network nodes of the telecommunication network;
cause the satellite to transmit the first TAC to the first tracking area,
wherein at least one wireless device is located in the first tracking area;
calculate a change to the coverage area of the satellite relative to the Earth;
determine that the coverage area of the satellite covers a second tracking area corresponding to a second TAC,
wherein the second tracking area corresponds to a second geographic location on the Earth; and
cause the satellite to transmit the second TAC to the second tracking area.

2. The non-transitory, computer-readable storage medium of claim 1, wherein the satellite is a first satellite in the non-terrestrial network, the instructions further cause the system to:
determine that a coverage area of a second satellite in the non-terrestrial network covers the first tracking area; and
cause the second satellite to transmit the first TAC to the first tracking area.

3. The non-transitory, computer-readable storage medium of claim 1, wherein the instructions further cause the system to:
measure an orbit of the satellite; and
calculate an expected location of the coverage area of the satellite based on the measured orbit of the satellite.

4. The non-transitory, computer-readable storage medium of claim 1, wherein the instructions further cause the system to:
map the first TAC to the first tracking area and the second TAC to the second tracking area; and
store the mapping of the first TAC and the second TAC in a database.

5. The non-transitory, computer-readable storage medium of claim 1, wherein the instructions further cause the system to:
cause the satellite to connect to a network node of a terrestrial network of the telecommunication network; and
receive, through the satellite, a list of TACs corresponding to different tracking areas.

6. The non-transitory, computer-readable storage medium of claim 1, wherein the first TAC is different from the second TAC.

7. The non-transitory, computer-readable storage medium of claim 1, wherein the instructions further cause the system to:
determine that the coverage area of the satellite overlaps with the first geographic location corresponding to the first TAC and the second geographic location corresponding to the second TAC;
partition the coverage area into multiple parts; and
cause the satellite to transmit the first TAC to the first geographic location and the second TAC to the second geographic location.

8. The non-transitory, computer-readable storage medium of claim 1, wherein the instructions further cause the system to:
receive from the at least one wireless device a tracking area update based on the at least one wireless device entering the first tracking area and receiving the first tracking area code.

9. A system comprising:
at least one hardware processor; and
at least one non-transitory memory storing instructions, which, when executed by the at least one hardware processor, cause the system to:
receive, at a wireless device, a first tracking area code (TAC) transmitted from a satellite in a non-terrestrial network of a telecommunication network,
wherein the wireless device is located in a first tracking area corresponding to a first geographic location on Earth;
receive, at the wireless device, a second TAC transmitted from the satellite,
wherein the wireless device receives the second TAC when the wireless device is located in a second tracking area corresponding to a second geographic location on Earth; and
transmit a tracking area update to the telecommunication network when the wireless device receives the second TAC,
wherein the tracking area update indicates a change in tracking area of the wireless device to the telecommunication network.

10. The system of claim 9, wherein the satellite is a first satellite in the non-terrestrial network, the system further caused to:
receive, at the wireless device, the first TAC from a second satellite in the non-terrestrial network,
wherein the wireless device is located in the first tracking area.

11. The system of claim 10, wherein the tracking area update is a first tracking area update and wherein the wireless device has moved back to the first tracking area from the second tracking area, further caused to:
transmit a second tracking area update when the wireless device receives the first TAC from the second satellite,
wherein a most recent TAC received by the wireless device is different from the first TAC.

12. The system of claim 9, wherein the satellite is a first satellite in the non-terrestrial network, the system further caused to:
receive, at the wireless device, the first TAC from the first satellite and a second satellite in the non-terrestrial network,
wherein the first satellite and the second satellite have an overlapping coverage area.

13. The system of claim 9, wherein the first TAC is different from the second TAC.

14. A method comprising:
calculating a coverage area of a satellite in a non-terrestrial network of a telecommunication network relative to Earth;
determining that the coverage area of the satellite covers a first tracking area corresponding to a first tracking area code (TAC),
wherein the first tracking area corresponds to a first geographic location on the Earth; and
wherein the TAC indicates to the telecommunications network a location of a wireless device within a group of network nodes of the telecommunication network;
causing the satellite to transmit the first TAC to the first tracking area,
wherein at least one wireless device is located in the first tracking area;
calculating a change to the coverage area of the satellite relative to the Earth;
determining that the coverage area of the satellite covers a second tracking area corresponding to a second TAC,
wherein the second tracking area corresponds to a second geographic location on the Earth; and
causing the satellite to transmit the second TAC to the second tracking area.

15. The method of claim 14, wherein the satellite is a first satellite in the non-terrestrial network, the method further comprising:
determining that a coverage area of a second satellite in the non-terrestrial network covers the first tracking area; and
causing the second satellite to transmit the first TAC to the first tracking area.

16. The method of claim 14, further comprising:
measuring an orbit of the satellite; and
calculating an expected location of the coverage area of the satellite based on the measured orbit of the satellite.

17. The method of claim 14, further comprising:
mapping the first TAC to the first tracking area and the second TAC to the second tracking area; and
storing the mapping of the first TAC and the second TAC in a database.

18. The method of claim 14, further comprising:
causing the satellite to connect to a network node of a terrestrial network of the telecommunication network; and
receiving, through the satellite, a list of TACs corresponding to different tracking areas.

19. The method of claim 14, wherein the first TAC is different from the second TAC.

20. The method of claim 14, further comprising:
determining that the coverage area of the satellite overlaps with the first geographic location corresponding to the first TAC and the second geographic location corresponding to the second TAC;
partitioning the coverage area into multiple parts; and
causing the satellite to transmit the first TAC to the first geographic location and the second TAC to the second geographic location.
